(19) United States
(12) Patent Application Publication
(10) Pub. No.: US 2026/0134768 A1
(43) Pub. Date: May 14, 2026

(54) Locator Tag Device

(71) Applicant: Justin Mason, Sanford, FL (US)

(72) Inventor: Justin Mason, Sanford, FL (US)

(21) Appl. No.: 19/032,176

(22) Filed: Jan. 20, 2025

Related U.S. Application Data
(60) Provisional application No. 63/551,203, filed on Feb. 8, 2024.

(51) Int. Cl. G08B 21/24; G08B 7/06; H02J 7/70

(52) U.S. Cl. CPC G08B 21/24; G08B 7/06; H02J 7/731

(57) ABSTRACT

A locator tag device is provided. The device is designed to aid in retrieving misplaced items by employing a tag module, a locator remote, and a charging station. Each tag module features versatile attachment mechanisms such as a keyring hole, adhesive backing, and/or a magnet. The modules are equipped with auditory and visual indicators for enhanced localization. The locator remote activates specific tag modules wirelessly using labeled buttons and includes its own indicators for locating the remote itself. A charging station serves as a docking and charging point for the remote and tag modules, as well as a signal emitter to locate the remote. Communication between components utilizes RF technology, ensuring interference-free operation. The invention also comprises a method for configuring and operating the device to efficiently locate both tagged items and the remote.

### CROSS-REFERENCE TO RELATED APPLICATION

The present application claims priority to, and the benefit of, U.S. Provisional Application No. 63/551,203, which was filed on Feb. 8, 2024, and is incorporated herein by reference in its entirety.

### FIELD OF THE INVENTION

The present invention relates generally to the field of locating devices. More specifically, the present invention relates to a locator tag device that aids in retrieving misplaced items using a tag module with versatile attachment mechanisms, a locator remote with labeled buttons and built-in indicators, and a charging station that also functions as a signal emitter. Communication between components relies on RF technology for interference-free operation, with auditory and visual cues enabling efficient localization of both tagged items and the remote. Accordingly, the present disclosure makes specific reference thereto. Nonetheless, it is to be appreciated that aspects of the present invention are also equally applicable to other like applications, devices, and methods of manufacture.

### BACKGROUND

Locating misplaced items is a common and often frustrating challenge in daily life. Items such as remotes, phones, and other household essentials are frequently misplaced, leading to wasted time and increased stress. While various technologies, such as smartphone apps and Bluetooth trackers, aim to address this issue, they often rely on complex setups or the availability of internet connectivity, which can make their usage less intuitive and reliable. Additionally, the process of pairing devices, maintaining connectivity, and dealing with dead batteries often reduces the convenience they aim to provide. For individuals who seek a straightforward solution to quickly locate misplaced items, these complications can be a significant barrier. Furthermore, the absence of a simple and reliable mechanism to ensure that a locator itself is not misplaced adds another layer of inefficiency. This underscores the necessity for an alternative solution that is both user-friendly and functional in a wide range of situations without relying on external infrastructure.

Therefore, there exists a long-felt need in the art for an improved lost item locating device that simplifies the process of locating personal items. There also exists a long-felt need in the art for a locator tag device that can locate lost items quickly and effectively without relying on internet connectivity. Moreover, there exists a long-felt need in the art for a locator tag device that ensures ease of use through dedicated buttons, a self-locating remote, and an independent power system.

The subject matter disclosed and claimed herein, in one embodiment thereof, comprises a locator tag device. The device is designed to aid in retrieving misplaced items by employing a tag module, a locator remote, and a charging station. Each tag module features versatile attachment mechanisms such as a keyring hole, adhesive backing, and/or a magnet. The modules are equipped with auditory and visual indicators for enhanced localization. The locator remote activates specific tag modules wirelessly using labeled buttons and includes its own indicators for locating the remote itself. A charging station serves as a docking and charging point for the remote and tag modules, as well as a signal emitter to locate the remote. Communication between components utilizes RF technology, ensuring interference-free operation. The invention also comprises a method for configuring and operating the device to efficiently locate both tagged items and the remote.

In this manner, the locator tag device of the present invention accomplishes all the forgoing objectives and provides a simple and efficient method to find lost items. The device employs a dedicated remote with individually labeled buttons, each corresponding to a specific tag. This enables users to locate items instantly with a single press, avoiding the complexities of pairing or internet dependency. The addition of a charging base ensures that the remote remains easily accessible, while the replaceable batteries for the tags enhance long-term functionality. By operating wirelessly on radio frequencies, the device eliminates reliance on Wi-Fi or Bluetooth, making it suitable for use in diverse environments. This comprehensive design addresses the identified needs by combining ease of use, reliability, and practicality, to offer a solution to the common problem of misplaced items.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a locator tag device designed for efficient retrieval of misplaced items. The device is comprised of a tag module that attaches securely to objects such as keys, wallets, and remote controls using various mechanisms, including a keyring hole, adhesive backing, and magnet. The tag module is enclosed in a water-resistant and durable housing made from materials such as ABS plastic or thermoplastic elastomer.

The tag module features an auditory indicator using a piezoelectric buzzer with adjustable sound levels and a visual indicator using LED lights to facilitate locating items in different environments. Multi-color LED options may also be included for distinct identification. Power is supplied by replaceable or rechargeable batteries, and rechargeable models include a charging port compatible with micro-USB, USB-C, wireless, or similar standards.

A wireless remote activates the tag module indicators to locate attached objects. The remote includes multiple buttons corresponding to specific tag modules, with customizable labeling options and LED backlighting to enhance usability in low-light conditions. The remote can also be located using a secondary auditory and visual indicator, activated by a button on either the tag module or the charging station.

The remote includes an integrated display or LED indicators to provide real-time battery status updates for connected tag modules. It is powered by a rechargeable battery and is recharged via a port compatible with USB or wireless connections. A dedicated charging station securely holds the remote during charging and functions as a signal emitter to activate the tracking feature for locating the remote.

Wireless communication between the tag modules, remote, and charging station is enabled through RF technology, ensuring reliable operation without reliance on Wi-Fi or Bluetooth and minimizing signal interference.

The method of use involves attaching the tag module to an object using one of the available mechanisms. The remote is configured by associating its buttons with specific tag modules and labeling the buttons for identification. To locate a misplaced object, the user presses the corresponding button on the remote to activate the auditory and visual indicators on the associated tag module. If the remote itself is misplaced, the tracking feature is activated by pressing a button on either the tag module or the charging station, which triggers the secondary auditory and visual indicators on the remote.

Accordingly, the locator tag device of the present invention is particularly advantageous as it provides a simple and efficient method to find lost items. The device employs a dedicated remote with individually labeled buttons, each corresponding to a specific tag. This enables users to locate items instantly with a single press, avoiding the complexities of pairing or internet dependency. The addition of a charging base ensures that the remote remains easily accessible, while the replaceable batteries for the tags enhance long-term functionality. By operating wirelessly on radio frequencies, the device eliminates reliance on Wi-Fi or Bluetooth, making it suitable for use in diverse environments. This comprehensive design addresses the identified needs by combining ease of use, reliability, and practicality, to offer a solution to the common problem of misplaced items.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of a tag module of one potential embodiment of a locator tag device of the present invention in accordance with the disclosed architecture;

FIG. 2 illustrates a front view of a locator remote of one potential embodiment of a locator tag device of the present invention in accordance with the disclosed architecture;

FIG. 3 illustrates a front view of a charging station of one potential embodiment of a locator tag device of the present invention in accordance with the disclosed architecture; and

FIG. 4 illustrates a flowchart of a method of using one potential embodiment of a locator tag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved lost item locating device that simplifies the process of locating personal items. There also exists a long-felt need in the art for a locator tag device that can locate lost items quickly and effectively without relying on internet connectivity. Moreover, there exists a long-felt need in the art for a locator tag device that ensures ease of use through dedicated buttons, a self-locating remote, and an independent power system.

The present invention, in one exemplary embodiment, is comprised of a locator tag device designed for efficient retrieval of misplaced items. The device includes a tag module that securely attaches to objects such as keys, wallets, and remote controls using mechanisms such as a keyring hole, adhesive backing, and magnet. The tag module is enclosed in a water-resistant and durable housing made from materials like ABS plastic or thermoplastic elastomer.

The tag module incorporates an auditory indicator using a piezoelectric buzzer with adjustable sound levels and a visual indicator using LED lights to assist in locating items in various environments. Multi-color LED options may be provided for distinct identification. The tag is powered by either replaceable or rechargeable batteries, with rechargeable models featuring a charging port compatible with micro-USB, USB-C, wireless, or similar standards.

A wireless remote activates the tag module indicators to locate attached objects. The remote features multiple buttons, each corresponding to a specific tag module, with customizable labeling options and LED backlighting for improved usability in low-light conditions. The remote itself can be located using a secondary auditory and visual indicator, activated by a button on the tag module or the charging station.

The remote also includes an integrated display or LED indicators to show the real-time battery status of connected tag modules. It is powered by a rechargeable battery and recharged via a port compatible with USB or wireless connections. A dedicated charging station securely holds the remote during charging and functions as a signal emitter to activate the tracking feature for locating the remote.

Wireless communication between the tag modules, remote, and charging station is achieved through RF technology, ensuring reliable operation without dependency on Wi-Fi or Bluetooth and reducing signal interference.

The method of use involves attaching the tag module to an object using one of the provided mechanisms. The remote is configured by associating its buttons with specific tag modules and labeling them for identification. To locate a misplaced object, the user presses the corresponding button on the remote to activate the auditory and visual indicators on the associated tag module. If the remote itself is misplaced, the tracking feature is triggered by pressing a button on the tag module or charging station, activating the remote's secondary indicators.

This locator tag device provides a straightforward and efficient solution for finding lost items. The dedicated remote with individually labeled buttons allows users to locate items with a single press, avoiding pairing complexities or internet reliance. The addition of a charging base ensures the remote remains accessible, and replaceable batteries for the tags enhance long-term usability. By employing radio frequency communication, the device operates reliably across various environments, addressing the common challenge of misplaced items with practicality and ease of use.

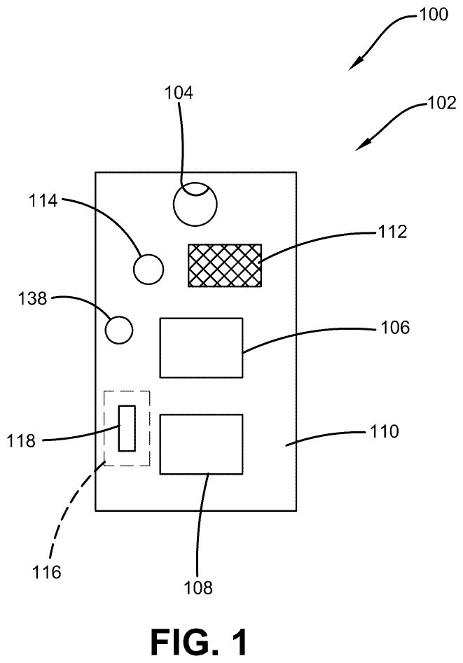

Referring initially to the drawings, FIG. 1 illustrates a front view of a tag module 102 of one potential embodiment of a locator tag device 100 of the present invention in accordance with the disclosed architecture. The present invention relates to a locator tag device 100 designed to facilitate the efficient retrieval of misplaced items. The device 100 is comprised of a tag module 102 that can be securely attached to various objects, including remote controls, keys, wallets, or other commonly misplaced items. Each tag module 102 features multiple attachment mechanisms, with one mechanism being an integrated keyring hole 104 for secure attachment to keyrings or similar accessories. Another mechanism includes a peelable adhesive backing 106 for attaching to flat objects, while a third mechanism is comprised of a magnet 108 for affixing to metal surfaces. Each tag module 102 is enclosed within a water-resistant housing 110 made from materials such as ABS plastic or thermoplastic elastomer, which provide durability and impact resistance.

Each tag module 102 includes an auditory indicator 112 in the form of a piezoelectric buzzer and a visual indicator 114 in the form of at least one LED light. The auditory indicator 112 emits configurable sound levels via a button 126 ranging from 50 dB to 90 dB to ensure audibility in different environments. The visual indicator 114 uses bright LEDs to enhance visibility in low-light or dark conditions. In one embodiment, the indicator 114 may flash. In one embodiment, multi-color LED options may be incorporated to allow color-based identification for specific modules 102.

Each tag module 102 is powered by replaceable or rechargeable batteries 116, such as coin-cell lithium batteries or rechargeable Li-ion cells. In one embodiment, each rechargeable tag module 102 may include an integrated charging port 118 designed to connect with a corresponding charging port 120 on a charging station 122. The charging ports 118 on the tag module 102 and the charging ports 120 on the charging station 122 may be configured as micro-USB, USB-C, wireless, or other compatible types to accommodate various charging methods.

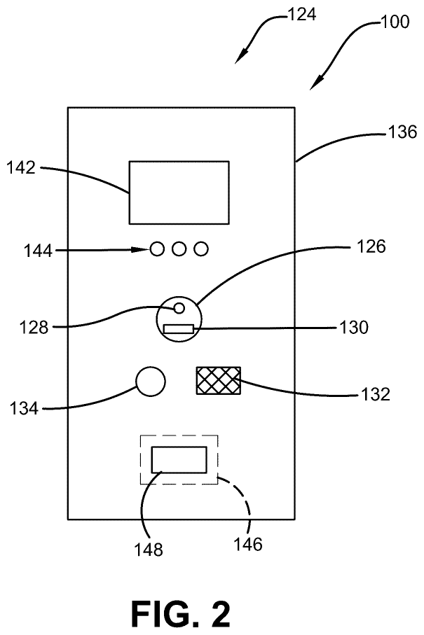

Each tag module 102 can be activated wirelessly by a locator remote 124, as seen in FIG. 2, which triggers simultaneous operation of both the auditory indicator 112 and the visual indicator 114 for locating the tag module 102 and the attached object. The locator remote 124 includes a plurality of individual buttons 126, each corresponding to a specific tag module 102. These buttons 126 can be labeled with pre-printed icons 128 or writable surfaces 130 for user-defined customization. Each button 126 may be an LED-backlit button to facilitate operation in dimly lit environments.

The remote 124 includes a second auditory indicator 132 and a second visual indicator 134 integrated into the remote 124 housing 136 to facilitate the location of the remote 124 by pressing a button 138 on the tag module 102 and/or a button 140 on the charging station 158. The second auditory indicator 132 is a piezoelectric buzzer configured to emit a distinctive sound with adjustable volume, ensuring the remote 124 is easily located in various environments. The second visual indicator 134 comprises high-intensity LEDs that may flash when the tracking feature is activated, providing a clear visual cue in both low-light and bright conditions.

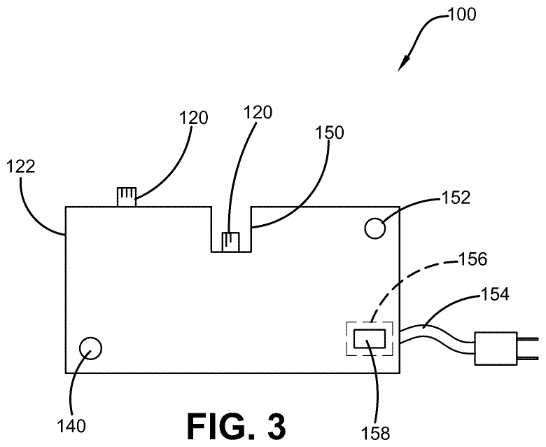

To enhance usability, the remote 124 includes an integrated display 142 and/or LED indicators 144 that provide real-time information on the battery 116 status of each connected tag module 102. The remote 124 is powered by a rechargeable battery 146 and includes a charging port 148, such as micro-USB, wireless, or USB-C, for convenient recharging by a charging port 120 of the charging station 122, as seen in FIG. 3. More specifically, the charging station 122 features a docking slot 150 for securely holding the remote 124 during charging. As noted, the charging station 122 also is comprised of a signal emitter 152, generating a low-power radio frequency signal to activate the tracking feature of the remote 124. This capability enables users to locate the remote 124 in case it becomes misplaced by pressing the button 140 on the charging station 122. The charging station 122 is preferably powered by a standard wall adapter 154 and/or is comprised of a battery 156 recharged via at least one charging port 158, such as but not limited to wireless or USB connections.

The tag module 102, remote 124, and charging station 122 communicate wirelessly with RF technology, which eliminates reliance on Wi-Fi or Bluetooth. A multi-frequency design prevents signal interference when multiple systems, including tag modules 102 and locator remotes 124, are in use within the same vicinity.

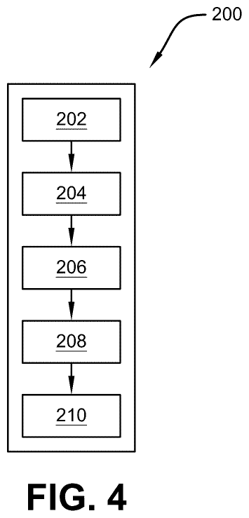

The present invention is also comprised of a method of using 200 the device 100, as seen in FIG. 4. First, a locator tag device 100 is provided, the device 100 comprised of at least one tag module 102, at least one remote 124, and at least one charging station 122 [Step 202]. The tag module 102 can then be securely attached to an object, such as a set of keys, a wallet, or a remote control, using one or more attachment mechanisms such as a keyring hole 104, an adhesive backing 106, or a magnet 108 [Step 204]. Next, the remote 124 can be configured by associating its individual buttons 126 with specific tag modules 102 and labeling the buttons 126 using pre-printed icons 128 or writable surfaces 130 for identification [Step 206]. To locate a misplaced item, the user presses the corresponding button 126 on the remote 124 to activate the auditory indicator 112 and the visual indicator 114 of the associated tag module 102, allowing the object to be found through audio and visual cues [Step 208]. In the event that the remote 124 is misplaced, the tracking feature can be activated by pressing the button 140 on the charging station 122 or the button 138 on the tag module 102, which activates the second auditory indicator 132 and second visual indicator 134 on the remote 124 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “locator tag device” and “device” are interchangeable and refer to the locator tag device 100 of the present invention.

Notwithstanding the forgoing, the locator tag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the locator tag device 100 as shown in the FIGS. are for illustrative purposes only, and that many other sizes and shapes of the locator tag device 100 are well within the scope of the present disclosure. Although the dimensions of the locator tag device 100 are important design parameters for user convenience, the locator tag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A locator tag device comprising:
a tag module configured for attachment to an object, the tag module further comprising:
an attachment mechanism;
a first auditory indicator configured to emit sound;
a first visual indicator;
a power source; and
a first charging port;
a locator remote comprising:
a button assigned to the tag module;
a second auditory indicator and a second visual indicator;
a second power source;
a second charging port;
a charging station comprising:
a third charging port configured to recharge the tag module and the locator remote;
a docking slot for securely holding the locator remote during charging;
a signal emitter configured to activate the first auditory indicator, the second auditory indicator, the first visual indicator, and the second visual indicator; and
wherein the tag module, the locator remote, and the charging station are in RF communication with each other.

2. The locator tag device of claim 1, wherein the attachment mechanism is comprised of a keyring hole.

3. The locator tag device of claim 1, wherein the attachment mechanism is comprised of an adhesive.

4. The locator tag device of claim 1, wherein the attachment mechanism is comprised of a magnet.

5. The locator tag device of claim 1, wherein the first visual indicator is comprised of an LED.

6. The locator tag device of claim 1, wherein the first auditory indicator is comprised of a piezoelectric buzzer.

7. The locator tag device of claim 1, wherein the second power source is rechargeable via the third charging port.

8. The locator tag device of claim 1, wherein the first power source is rechargeable via the third charging port.

9. The locator tag device of claim 1, wherein the first charging portion is comprised of a wireless charging port.

10. The locator tag device of claim 1, wherein the second charging portion is comprised of a wireless charging port.

11. The locator tag device of claim 1, wherein the third charging portion is comprised of a wireless charging port.

12. A locator tag device comprising:
a tag module configured for attachment to an object, the tag module further comprising:
an attachment mechanism;
a first auditory indicator configured to emit sound;
a first visual indicator;
a power source; and
a first charging port;
a locator remote comprising:
a first button assigned to the tag module;
a second auditory indicator and a second visual indicator;
a second power source;
a second charging port;
a charging station comprising:
a third charging port configured to recharge the tag module and the locator remote;
a docking slot for securely holding the locator remote during charging;
a second button that can be pressed to locate the locator remote;
a signal emitter configured to activate the first auditory indicator, the second auditory indicator, the first visual indicator, and the second visual indicator; and
wherein the tag module, the locator remote, and the charging station are in RF communication with each other.

13. The locator tag device of claim 12, wherein the first visual indicator is comprised of a flashing LED.

14. The locator tag device of claim 12, wherein the first visual indicator is comprised of a multi-colored LED.

15. The locator tag device of claim 12, wherein the first button is comprised of an LED backlit button.

16. The locator tag device of claim 12, wherein the locator remote magnetically attaches to the docking slot.

17. The locator tag device of claim 12, wherein the locator remote can be located via the second auditory indicator and the second visual indicator.

18. The locator tag device of claim 12, wherein the tag module can be located via the first auditory indicator and the first visual indicator.

19. A method of using a locator tag device, the method comprising the following steps:
providing a locator tag device comprised of a tag module, a locator remote, and a charging station;
attaching the tag module to an object using an attachment mechanism of the tag module;
configuring the locator remote by associating a first button of the locator remote with the tag module;
pressing the first button on the locator remote to activate the first auditory indicator and the first visual indicator on the tag module to locate the tag module; and
activating a tracking feature on the locator remote by pressing a second button on the charging station to trigger a second auditory indicator and a second visual indicator of the locator remote.

20. The method of using a locator tag device of claim 19, wherein the tag module, the locator remote, and the charging station are in wireless RF communication.
